(19) United States
(12) Patent Application Publication
(10) Pub. No.: US 2003/0187695 A1
(43) Pub. Date: Oct. 2, 2003

(54) ACSAS (automated claims settlement acceleration system)

(76) Inventor: Hollis Deon Drennan, Abilene, TX (US)

Correspondence Address: Mr. Hollis D Drennan, 2414 Rountree, Abilene, TX, 79601, US

(21) Appl. No.: 10/403,292

(22) Filed: Apr. 1, 2003

Related U.S. Application Data
(60) Provisional application No. 60/368,597, filed on Apr. 1, 2002.

(51) Int. Cl. G06F 17/60

(52) U.S. Cl. 705/2; 705/4

(57) ABSTRACT

An automated claims settlement acceleration system for the healthcare industry, which allows providers to receive immediate payment or re-imbursement at the point of service or time of confirmation of claim acceptance by the insurance entity.

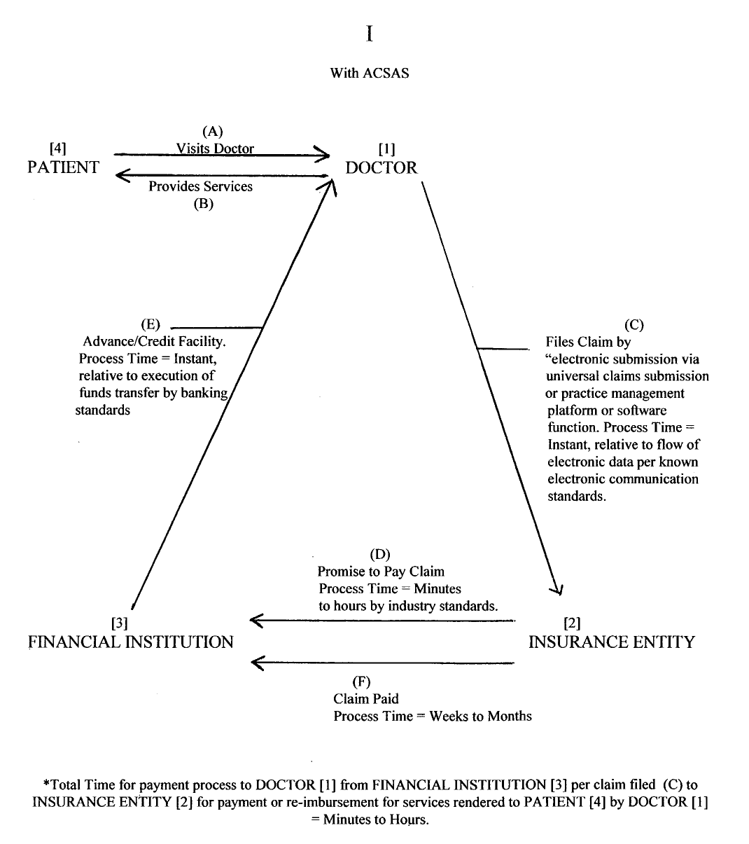

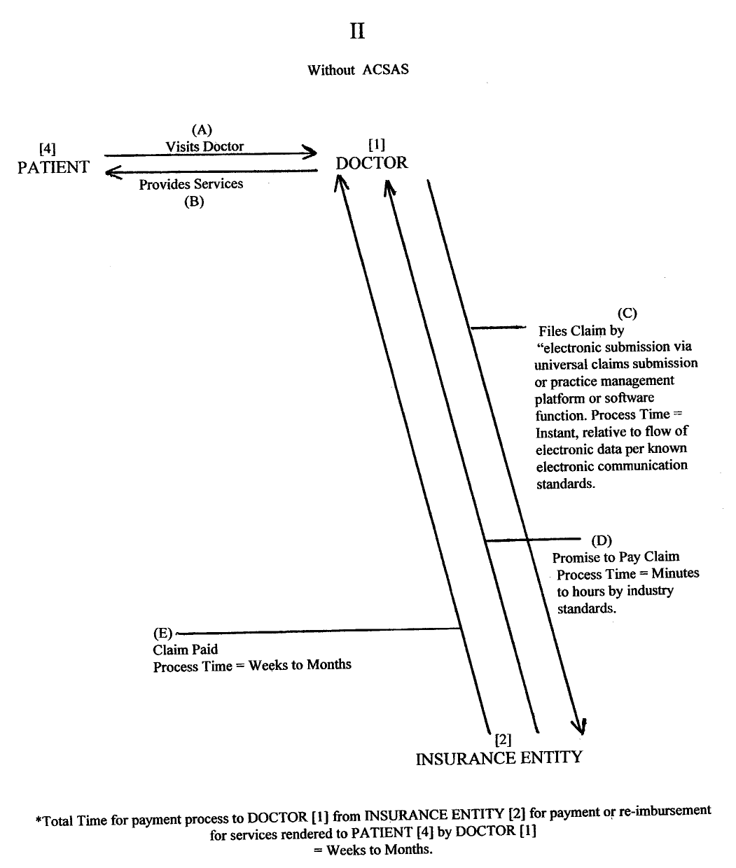

The system includes a software application which creates and manages a transactional relationship between the healthcare providers electronic claims submission platform of choice, the insurance entity's electronic response function for confirmed or approved claims, and a third party financial institution. The software application identifies and interprets the insurance entity's electronic response function signal and then uses that signal, or the information within, to execute electronic payment instructions, which direct the third party financial institution to execute a direct deposit transaction to an account designated for the healthcare provider.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING . . .

Not Applicable

### BACKGROUND OF INVENTION

The ACSAS invention is a transaction method that accelerates the payment process to end claimants or vendors from the insurance industry on behalf of claimant individuals, groups or entities. The ACSAS invention addresses the extensive delays, of weeks or months, the healthcare industry experiences between claims submissions to the insurance industry, confirmation of those claims by the insurance industry, and payment or re-imbursement to the healthcare industry, by the insurance industry, on a claim specific basis. The ACSAS invention is based on no specific prior art or patent.

A full search for prior art or patent within the USPTO Web Patent Database returned only two references under the classification Field of Search class & sub class 705/2, 4. The search reference returned two applications, numbers 031968 and 118668 respectively. The latter of which resulted in U.S. Pat. No. 6,343,271.

According to the Healthcare Finance Administration (HCFA), in the year 2000, as reported by the Centers for Medicare and Medicaid Services, Office of the Actuary, National Health Statistics Group, 85% of all healthcare monies paid in America are paid by some form of insurance. Roughly 80% of all healthcare providers income in America are derived by some form of insurance payment or reimbursement. The New England Journal of Medicine reports that 43.7% of a doctors gross income is accounted to overhead and billing expense. The Medical Group Management Journal reports survey statistics showing 11% of a practices total gross income is attributed to internal billing cost. According to the HCFA the average process time for payments or re-imbursements to reach the doctor from the insurance entities after claims are submitted is 90 to 120 days.

This delay for payment or re-imbursement process coupled with the high overhead expense of claims and payment administration is a significant factor in the ever escalating cost of healthcare administration in America, both to the overall financial stability of the healthcare industry and to the direct effect the current process has on the income and financial stability of individual healthcare providers. The average healthcare provider today has more than $132,000.00 in outstanding year end re-imbursement receivables.

Historically, insurance payments and re-imbursements are facilitated through a cumbersome and time consuming process of submitting payment claims information and patient medical information on an industry standard paper submission form called an HCFA-1500 form (HCFA=Healthcare Finance Administration). The forms are filled out by the healthcare provider and mailed to the insurance entity for processing after which payment or re-imbursement is eventually mailed back to the doctor who submitted the original claim. This process is referred to within the industry as a “Paper claim,” or “Paper claims Submission,” referring to the paper forms used to submit the claim to the insurance entity and accounts for about 60% of all claims filed as of the year 2000.

The healthcare industry's best alternative solution to the problems inherent with a “Paper claim,” submission process has been to adopt a new process known as EMC or Electronic Media claims Submission. Electronic Media claims Submission, or automated input refers to the process of submitting an insurance claim from one computer to another via modem directly to an insurance entity or clearinghouse on behalf of an insurance entity which then facilitates translation and forwarding of the electronic claims information specific to the individual insurance entities transaction standards. The electronic claim is then processed by the insurance entity and payment or re-imbursement is then mailed to the doctor who originally filed the claim. The electronic filling process is faster and more efficient than the “paper” claims process and also reduces the waiting period for payment or re-imbursement to the doctor from the insurance entity to as little as 14 to 21 days, or weeks not months.

As of the year 2000, EMC claims submission accounted for almost 40% of all claims submitted. The migration from “paper” claims to the new EMC submission format is growing at a substantial rate and is being pushed forward by legislative support in The United States. In 1996, President Clinton signed into law (Public Law 104-191) the Kassenbaum-Kennedy Bill, entitled the Health Insurance Portability and Accountability Act (HIPAA). The HIPAA has an “Administration Simplification” provisions section, which was intended to improve the efficiency and effectiveness of the healthcare system.

All healthcare providers, plans, and clearinghouses are effected by the Federally mandated uniform standards for electronic healthcare transactions. The United States government believes that the Administrative Simplification provisions of the HIPAA law will help lower the cost and administrative burdens of our healthcare system. Further to this position, current laws under HIPAA and ASCA (Administration Simplification Compliance Act) specifically prohibit HHS (Health and Human Services) from paying Medicare claims that are not submitted electronically after Oct. 16, 2003 unless the Secretary grants a waiver from this requirement. In the year 2000, Medicare expenditures represented about 17% of overall health spending in America thereby exerting a significant influence on overall spending trends and market direction.

### BRIEF SUMMARY OF THE INVENTION

The ACSAS invention (Automated claims Settlement Acceleration System) is a transaction method which serves as an integrated automated claims settlement system for billing applications in the electronic medium. ACSAS is to be used by and is adaptable to any electronic medium billing, claims submission, or full service practice management application platform, which meets transactional standards set forth by HIPAA. ACSAS executes payment to an end vendor or claimant, specifically a healthcare provider or agent of the healthcare provider, via transaction notification executing direct deposit by a third party financial institution, immediately upon confirmation of acceptance, or promise to pay, from an insurance or underwriting entity, based on prior specific claim submission by the healthcare provider, or agent thereof, to the insurance entity for re-imbursement of, or in anticipation of, services rendered to a covered individual or policy holder of the insurance entity.

The ACSAS invention delivers exclusive advantage to the healthcare provider by eliminating the substantial waiting period, or reducing that period from weeks and months to hours, for payment or re-imbursement from the insurance industry for services rendered by the healthcare provider by executing payment or re-imbursement, of covered procedures, to the healthcare provider, immediately upon confirmation from the insurance industry or entity of coverage payment due, procedural payment due, or promise to pay owed, by the insurance entity, to the healthcare provider, or agent thereof.

### BRIEF DESCRIPTION OF THE SEVERAL VIEWS OF THE DRAWING

Drawing I depicts a transactional flowchart of the claims submission and payment process relative to the relationship between the patient, healthcare provider (or DOCTOR), and insurance entities, while applying the ACSAS invention.

Drawing II depicts a transactional flowchart of the claims submission and payment process relative to the relationship between the patient, healthcare provider (or DOCTOR), and insurance entities, without the advantage of the ACSAS invention. {see DETAILED DESCRIPTION OF THE INVENTION section for detailed description drawing elements}

### DETAILED DESCRIPTION OF THE INVENTION

The ACSAS invention (Automated claims Settlement Acceleration System) is a transaction method which serves as an integrated automated claims settlement system for billing applications in the electronic medium. ACSAS is to be used by and is adaptable to any electronic medium billing, claims submission, or full service practice management application platform, which meets transactional standards set forth by HIPAA.

The current art or technology in the healthcare industry relative to insurance claims submission in the electronic medium is manifested throughout a number of platforms or applications from billing specific software programs, tele-file access via direct dial telephone system, to full service practice management applications, all of which are inclusive of software based platforms, phone modem platforms, internet or web based server platforms, and/or a combination of all the above. There even exist a technology platform, such as described by Boyer et al. in U.S. Pat. No. 6,208,973, requiring an extensively elaborate POS (Point of Sale) transaction terminal network which requires a specific “credit card” or “smart card” issued for the specific transaction and tied directly to the POS terminal function. This POS technology requires POS terminal installation at multiple locations including the healthcare provider office and the administrative office of the designated insurance payer in order to provide “Point of Sale Adjudication” of patient coverage relative to co-pay responsibility.

Regardless of the platform or application chosen, all insurance claims submission applications or technology platforms currently in existence, dedicated to the electronic medium, have a significant common denominator relative to their transactional relationship and interaction with the insurance entity. The significant common denominator is the electronic signal, which is the return response or action response, from the insurance entity to the healthcare provider or agent thereof, in direct response to an individual claim filed or submitted to the insurance entity. This is commonly referred to as the “promise to pay,” or confirmation of benefits. The “promise to pay” can be received back from the insurance entity within seconds or minutes from the time an EMC (electronic media claims) submission is received by the insurance entity from the doctor, even though the actual payment or re-imbursement to the doctor from the insurance entity, may not be sent, by mail or otherwise, for several weeks or months.

As a descriptive example of the “promise to pay” or “confirmation of benefits” action response, in a software based platform application environment, the “promise to pay claim” is identified in {drawing II} as line (D) between the doctor and the insurance entity. The patient [4] receives services from the doctor [1] who records the details of the services rendered into a common software program which prepares the patient transaction records according to HIPAA compliant standards and sends the insurance claim, designated by line (C), to the insurance entity [2] in “electronic media claims” format. Within minutes, the insurance entity [2] sends an electronic message or “action response” back to the doctor which is the “promise to pay claim” (D) which gives the doctor [1] the exact parameters of said claim (C) previously filed including the exact dollar amount to be paid or reimbursed to the doctor [1] by the insurance entity [2] based on patient visit [4](A) as recorded in filed claim (C).

The ACSAS invention is an integrated transaction module which identifies, interprets, and reconciles the execution of the electronic signal, (known and discussed above as action response, return response, “promise to pay claim,” or confirmation of benefits), from the insurance entity, insurance clearinghouse, or agent thereof, in order to execute instructions for a direct deposit transaction between a third party financial institution and the healthcare provider or doctor, in the dollar amount(s) designated in the “promise to pay claim” action response, received from the insurance entity in reply to the claim filed by the healthcare provider or doctor. The ACSAS invention is intended as a stand alone software module which automatically adapts itself to all major existing, universally accepted, billing or claims submission platforms dedicated to the electronic media and serves as an integrated automatic data transaction manager which executes a seamless transaction process between a doctor, insurance entity, and third party financial institution.

The ACSAS invention is completely new and simplistically unique to the healthcare industry and deals solely and exclusively with the EMC mode of pre-authorized insurance claim payment or reimbursement notification function(s) to trigger or execute a financial transaction between the healthcare provider and a third party financial institution. The ACSAS invention does not make any identification, determination, or interpretation of policy benefits coverage, or payment, or co-payment responsibility as described in the Boyer U.S. Pat. No. 6,208,973, and others. The purpose of the ACSAS invention is to satisfy the single simple function of creating and managing the transaction relationship between the healthcare provider, insurance entity, and the financial institution, relative to the reconciliation of the financial obligations between doctor and insurance entity.

To date, the main focus in developing new automation technologies for the healthcare industry have dealt with the claims submission process and in creating a more efficient payment process for the portion of the payment which can be determined at the time of service. Additional efforts are in the focus area's of POS, or Point of Sale, adjudication methods or processes, including providing third party payment at the point of service via credit cards or accounts on behalf of the consumer or patient who can earn discounts or “cash back” credits based on usage.

Many claims and attempts have been made to “accelerate” the payment or re-imbursement process, for both the healthcare provider, and the patient as an end consumer. Existing claims or art discuss the intent or generic concept of accelerating the payment cycle as a result of a specific claimed function or purpose non-specific to payment of electronic claims from the insurance entity to the healthcare provider. Claims of this type claims are not specific to, and do not create or communicate the purpose or intent to, specifically address the creation of a triangular relationship between a healthcare provider's claims submission platform, an insurance entity's electronic claim response function, and a third party financial institution.

Other claims or art have the effect of an “accelerated” payment cycle as an ancillary result of a function or process of an “other intentioned,” intended, or purpose technology in much the same way that the EMC submission process has accelerated the payment process to the doctor over the previously used universal format of paper claims submission methods by converting all communications to the faster, more efficient electronic data exchange format. The process described in Boyer et al. U.S. Pat. No. 6,208,973 has the effect of, and creates an “accelerated” payment cycle by virtue of expanded POS “adjudication” processes, and more efficient coverage determination abilities, utilizing a POS terminal network in conjunction with “smart cards” and/or co-branded credit cards which by nature of the very existence of a credit card also creates a “third party” relationship, arms length as it may be, with a bank, financial institution, or “internet bank” as claimed in the Boyer Patent. The mere existence of a “relationship” with a “third party” “internet bank” does not create, execute, or communicate the purpose or intention to create the relationship or results of the application of the ACSAS invention.

No known technology, process or art exist today which provides for the automatic creation and management of a seamless electronic transaction relationship between: (a) the healthcare provider's electronic claims submission platform of choice, (b) the insurance entity's electronic response function, and, (c) a specifically designated financial institution.

The following description details the simple logic of the ACSAS invention as identified in Drawings I, and II. Drawing I depicts the electronic claims submission process with the benefit of the ACSAS invention technology. Drawing II depicts the claims submission process, as it exists today, without the benefit of the ACSAS invention technology.

Drawing I

The ACSAS invention provides payment to an end vendor [1] (vendor=a DOCTOR or healthcare provider), immediately upon confirmation of payment due, or promise to pay, from an INSURANCE ENTITY [2] (INSURANCE ENTITY=an insurance company, underwriter, or other entity serving the function of an insurance company, HMO or other similar group). Payment to the vendor [1] is made in the form of a credit facility such as a loan, line of credit, or credit advance from a third party FINANCIAL INSTITUTION or entity [3] (FINANCIAL INSTITUTION=a bank, credit card company or other credit underwriting entity, group or individual providing similar credit or financial services). Payment from the FINANCIAL INSTITUTION [3] to the vendor [1] is made based upon the prior promise or commitment to pay from the INSURANCE ENTITY [2] to the vendor [1] originated from a claim filed by/or on behalf of benefits or payment due to a third party claimant [4] (third party claimant=PATIENT, an individual, group, entity or association who hold some benefit by prior contractual policy or contract for payment of certain good and or services by an insurance company [2]). The vendor [1] assigns its rights to collect said payment from INSURANCE ENTITY [2] to the FINANCIAL INSTITUTION [3] in exchange for the credit facility or advance payment from the FINANCIAL INSTITUTION [3] to the vendor [1]. The credit facility or payment by FINANCIAL INSTITUTION [3] to vendor [1], based on the prior promise or commitment to pay from the INSURANCE ENTITY [2], is considered satisfied, re-paid or reconciled upon payment from the INSURANCE ENTITY [2] to the FINANCIAL INSTITUTION [3] in consideration of the credit facility, payment or advance previously paid to vendor [1] by FINANCIAL INSTITUTION [3] based on the promised payment to vendor [1] from INSURANCE ENTITY[2].

A descriptive example of an application of ACSAS as specified above would be a PATIENT [4] receives services from a DOCTOR [1] in which said services are covered for payment by an insurance company [2]. The DOCTOR [1] files a claim with the INSURANCE ENTITY [2], for the services provided to the PATIENT [4]. The INSURANCE ENTITY [2] responds to the DOCTOR [1] with a promise to pay according to the terms of the insurance policy issued to the PATIENT [4] by the INSURANCE ENTITY [2]. The promise to pay is forwarded to the FINANCIAL INSTITUTION [3] who processes the transaction and makes an immediate payment to the DOCTOR [1] based on the promise to pay from the insurance company [2] which creates a credit facility. The DOCTOR [1] assigns the right to collect the payment from the insurance company [2] to the FINANCIAL INSTITUTION [3] as collateral for the credit facility. When the claim is ultimately paid by the insurance company [2], it is paid directly to the FINANCIAL INSTITUTION [3] and the credit facility, extended to the DOCTOR [1] by the FINANCIAL INSTITUTION [3] based on the original promise to pay from the insurance company [2], originated by the services rendered to the PATIENT [4], by the DOCTOR [1]. The credit facility is considered paid in full and or fully satisfied and the transaction is complete. *Total Time for payment process to DOCTOR [1] from FINANCIAL INSTITUTION [3] per claim filed (C) to INSURANCE ENTITY [2] for payment or re-imbursement for services rendered to PATIENT [4] by DOCTOR [1]=Minutes to Hours.

### Drawing II

The PATIENT [4] visits (A) the DOCTOR [1] who provides services (B) to the PATIENT [4]. The DOCTOR [4] makes a record of the services rendered and submits a claim (C) by electronic transaction via universal claims submission or practice management platform or software application, to the INSURANCE ENTITY [2] which then submits a return action or response (D), sometimes within minutes or hours, to the DOCTOR [1] as a “promise to pay claim,” which includes the financial parameters of the claim to be paid to the DOCTOR [1] by the INSURANCE ENTITY [2]. The INSURANCE ENTITY then processes the claim and sends payment (E) to the DOCTOR [1] to settle the claim originally filed by the DOCTOR [1] for payment or re-imbursement for services rendered to the PATIENT [4]. *Total Time for payment process to DOCTOR [1] from INSURANCE ENTITY [2] for payment or re-imbursement for services rendered to PATIENT [4] by DOCTOR [1] Weeks to Months.

The ACSAS invention gives the DOCTOR[1] the ability to receive payment for services rendered immediately upon filling a claim with the INSURANCE COMPANY[2], and receiving confirmation of benefits or “promise to pay claim.” The DOCTOR [1] can receive payment at the point of service or as soon as services are confirmed by the INSURANCE COMPANY[2] at either the time of service or within 2448 hours. ACSAS can be applied as a stand alone function or in conjunction with any automated electronic claims submission service or clearinghouse providing such or similar automated claims submission service or electronic claims submission service.

### SUMMARY OF THE INVNETION

The ACSAS invention satisfies the financial needs of the healthcare industry by providing a user friendly solution to healthcare providers which enables them to receive immediate payment or reimbursement for services rendered based on confirmed claims or “promise to pay claims” from an insurance entity.

In a preferred embodiment, which is identified here as the best known mode of the invention, the ACSAS invention includes a software application which is a “self installed” platform which creates a transactional relationship between the healthcare providers electronic claims submission platform of choice, the insurance entity's electronic response function for confirmed or approved claims, and a third party financial institution. The software application identifies and interprets the insurance entity's electronic response function signal and then uses that signal, or the information within, to execute electronic payment instructions which direct the third party financial institution to execute a direct deposit transaction to an account designated for the healthcare provider.

The ACSAS invention will improve the overall state of healthcare in America by helping providers eliminate the cash-flow problems and extremely high overhead expense problems inherent in healthcare today as a result of the long waiting period that exist between the point of service and the point of payment or re-imbursement from the insurance industry. The average healthcare provider today has outstanding year end re-imbursement receivables of $132,000.00 Industry wide this figure totals more than $47 Billion each year. The ACSAS invention has an undeniable practical application in the healthcare industry and exhibits tremendous “real world value” by empowering healthcare providers to completely eliminate this figure focus on their most important “real world” issue, which is quality patient care. Greater quality patient care, results in, fewer legitimates malpractice claims against providers. Fewer malpractice claims results in lower insurance premiums for healthcare providers which translates to lower treatment cost for patients which lessens the burden of insurance in healthcare which helps lower the over all cost in healthcare spending in America.

Those skilled in the art will appreciate that even though the ACSAS invention serves a specific purpose and function, to the benefit of the healthcare industry, as set forth in the foregoing description, numerous alternate embodiments are possible without departing from the novel teachings of the invention. For example, ACSAS (Automated claims Settlement Acceleration System) can be used in any scenario whereby a “service provider” receives a delayed payment or re-imbursement, from a separate insurance entity. Examples would include but are not limited to, automobile insurance claims, homeowner claims, personal liability claims, and personal property claims.

We claim:

1. An automatic insurance claims settlement acceleration system that executes payment for insurance claims at the point of service or upon confirmation of claim payment by an insurance entity.

2. A system as in claim 1, that executes payment to a provider of service via direct deposit immediately upon confirmation of claim acceptance by an insurance entity.

3. A system as in claim 1, that is a stand alone program that creates and manages the transactional relationship between the three points of: (a) a healthcare providers electronic claims submission platform of choice, (b) the insurance entities electronic response function, and (c) a third party financial institution.

4. A system as in claim 1, that is a stand alone software module that; when installed on a computer or platform designated at a healthcare providers location, or the location of an agent thereof charged with the management of the providers electronic claims submission software or platform or full service practice management software or platform which facilitates the electronic claims submission functions for the provider, the module program will automatically detect the providers emc (electronics media claims) submission platform and monitor the emc submission platform for any return response signals, which are the confirmation of benefits or promise to pay claim response from an insurance entity sent in response to a previously filed claim by a healthcare provider for payment or re-imbursement for services rendered; the program then uses that return response signal, or promise to pay claim signal, to execute payment instructions in the form of a direct deposit transaction to an account designated for the provider to receive payment or reimbursement from a third party financial institution, based on the parameters set out in the return response or promise to pay claim from the insurance entity for a claim filed by or on behalf of the healthcare provider.

5. A system as in claims 1, 2, 3, and claim 4, that creates a specific transactional relationship between the healthcare provider, insurance entity, and a third party financial institution, for the sole and specific purpose of providing immediate payment to the provider for insurance claims filed by the provider to the insurance entity which claims are confirmed by the insurance entity.
